(19) United States
(12) Patent Application Publication
(10) Pub. No.: US 2018/0242599 A1
(43) Pub. Date: Aug. 30, 2018

(54) Expanded Cheese Snacks and Method for Making Same

(71) Applicant: Frito-Lay North America, Inc., Plano, TX (US)

(72) Inventors: Michael ADAMS, Plano, TX (US); Adam BROSKI, Dallas, TX (US); Vamshidhar PUPPALA, McKinney, TX (US); Chad WOELFLE, Farmers Branch, TX (US)

(21) Appl. No.: 15/441,302

(22) Filed: Feb. 24, 2017

(51) Int. Cl. A21D 13/40; A23C 19/068

(52) U.S. Cl. CPC A21D 13/40; A23C 19/068

(57) ABSTRACT

A yeast-free dough contains at least 40% natural cheese. The natural cheese is mixed with wheat flour, pregelatinized starch, and water to make a non-laminated dough, which is then sheeted, cut and dehydrated. The finished product has a peak force hardness of between about 15,000 to about 30,000 grams and an expanded internal air cell structure throughout and a bulk density of from about 100 to about 400 g/L.

### BACKGROUND OF THE INVENTION

### Technical Field

A method of making shelf-stable expanded cheese snacks is described herein. More specifically, a method for delivering significant amounts of natural cheese made directly from milk into snack foods is described herein.

### Description of Related Art

Snack foods incorporating cheese typically formulate their product with dried cheese in the form of powders. Such powders are often easier to work in terms of shipment and processing. However, there is a desire for snack products that incorporate natural or aged cheeses, which are made directly from milk. Such cheeses are typically more challenging to work with; consequently, incorporating significant amounts of these cheeses into shelf stable snack food products is also a challenge. Forming a cohesive dough that can be processed successfully with such cheese can be a challenge due to sheeting issues driven partly by the high moisture and fat contents of the cheese. There is a need for that incorporate significant amounts of natural cheese into expanded snack food products comprising shelf-stable moisture contents.

### SUMMARY OF THE INVENTION

Provided herein is a method of making a shelf-stable, low moisture, crispy expanded cheese-based snack food products comprising significant amounts of natural cheese. The product incorporates high amounts of natural cheese into a dough that is subsequently sheeted and dehydrated to create shelf-stable foods. Below is a simplified summary of this disclosure meant to provide a basic understanding of some aspects of the products and methods described herein. This is not an exhaustive overview and is not intended to identify key or critical elements or to delineate the scope of the description. Its sole purpose is to present some concepts in a simplified form as a prelude to the more detailed description below.

In one aspect, a method of making a snack food comprises the steps of mixing wheat flour, pregelatinized starch, natural cheese, and water to form a cohesive dough, the natural cheese comprising a moisture greater than 5% and the cohesive dough comprising at least about 40% natural cheese; sheeting the cohesive dough to form a sheeted dough; cutting the sheeted dough to form a plurality of cut pieces; and dehydrating the cut pieces to less than 10% moisture to form a snack food comprising at least about 35% natural cheese.

In another aspect, a cheese-based shelf stable snack food product comprises at least about 35% natural cheese, the natural cheese comprising at least 15% fat; between about 23% to about 30% wheat flour; between about 23% to about 30% pregelatinized starch; a moisture content of less than 4%; and a peak force hardness of between about 15,000 to about 30,000 grams.

In another aspect, a dough comprises between about 15% to about 28% wheat flour; between about 15% to about 25% pregelatinized starch; at least 40% natural cheese, the natural cheese comprising an unprocessed, non-powder cheese; between about 1% to about 12% added water; and a mean storage modulus from between about 23 to about 44 kPa, at 21° C. and an angular frequency of 10 rad/s.

Other aspects, embodiments and features of the invention will become apparent in the following written detailed description and accompanying drawings.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 shows the storage modulus G′ and loss modulus G″ from three doughs made with suitable cheeses for use in some embodiments of the method disclosed herein.

FIG. 2 is a bar graph demonstrating the mean hardness (g) of cheese snacks described herein versus prior art cheese snacks.

FIG. 3 is a CT-scan image of the internal pore structure of one embodiment of the cheese snack described herein.

### DETAILED DESCRIPTION OF THE INVENTION

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The term comprising means “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified in the claim. As used herein, “up to” includes zero, meaning no amount is added in some embodiments.

The term “about” generally refers to a range of numerical values (e.g., +/−1-3% of the recited value) that one of ordinary skill in the art would consider equivalent to the recited value (e.g., having the same function or result). In some instances, the term “about” includes the values disclosed and may include numerical values that are rounded to the nearest significant figure. Moreover, all numerical ranges herein should be understood to include all integer, whole or fractions, within the range recited. Several embodiments for snack foods described herein and methods for making same will now be described.

Generally, the method for making the cheese-based snack foods as described herein comprises the steps of mixing wheat flour, pregelatinized starch, natural cheese, and water to form a dough; sheeting the dough; forming the sheeted dough into snack-sized pieces; and dehydrating the pieces to less than 10%. In some embodiments, the pieces are dehydrated to less than 4%. In certain embodiments, the method comprises a second dehydrating step to dry the pieces to a finished product moisture of less than about 4%. In some embodiments, the finished product moisture is between about 2% to about 3%.

The cohesive dough formed in the mixing step generally comprises less than 30% wheat flour. In one embodiment, the cohesive dough comprises between about 15% to about 28% wheat flour. In certain embodiments, the cohesive dough comprises between about 18% to about 24% wheat flour. In certain embodiments, the cohesive dough comprises between about 21% to about 24% wheat flour. In certain embodiments, the wheat flour comprises a flour protein content of between about 8% to about 15% by weight. In other embodiments, the wheat flour comprises a flour protein content of between about 9% to about 12% by weight.

The cohesive dough further comprises between about 15% to about 28% pregelatinized starch. The term “pregelatinized starch”, when used herein, is meant to refer to a starch that has been chemically, mechanically, and/or thermally treated in the presence of water to decrease the number and/or size of crystalline regions and increase the randomness in the general structure, followed by steps to convert the starch into flake or powder form. In some embodiments, the pregelatinized starch comprises a particle size distribution wherein >50% passes through a 200 mesh sieve. The term “pregelatinized” refers to a high degree (>90%) of gelatinization in the starch prior to the formation of the dough as described herein. The combination of wheat flour and pregelatinized starch results in a degree of gelatinization of the starch in the dough that is greater than 50%. In some embodiments, the dough comprises between about 18% to about 24% pregelatinized starch. In some embodiments, the dough comprises between about 19% to about 22% pregelatinized starch. In any embodiment described herein, the pregelatinized starch comprises corn starch. In some embodiments, the pregelatinized starch comprises a modified starch. As used herein, a “modified starch” refers to starch that has been physically or chemically altered to improve its functional characteristics. In some embodiments, the pregelatinized starch comprises an unmodified starch. In some embodiments, the unmodified starch comprises an unmodified corn starch. An “unmodified starch” refers to the form of the starch, which may or may not have been physically treated, but has not been chemically treated to modify its structure.

The formed cohesive dough should comprise at least about 40% natural cheese. In one embodiment, the cohesive dough comprises between about 40% to about 55% natural cheese. In another embodiment, the cohesive dough comprises between about 45% to about 50% natural cheese. Natural cheese refers to cheese made directly from milk, as opposed to processed cheeses that are not manufactured directly from milk but are rather produced by combining natural cheese with other ingredients to form a blend that is heated to form a homogenous product with no byproducts. The term “natural cheese,” as used herein, includes only unprocessed cheese(s) (i.e., free of processed cheese) and also refers to cheese comprising at least 5% moisture and thus excludes dried cheeses such as in powder form. In some embodiments, the natural cheese comprises a moisture content greater than 10%. Suitable natural cheeses, by way of example, comprise any milk made from cows, domestic buffaloes, sheep, goats, or other ruminant animals, which is treated with clotting enzymes, such as rennet, and/or created by acidification to coagulate the milk. In another embodiment, the cheese is one made from whole or part skimmed milk. In one embodiment, the natural cheese comprises shredded or grated cheese, or a combination of shredded and grated cheese. In some embodiments, the natural cheese comprises Parmesan, Cheddar, mozzarella, Gouda, Gruyère, provolone, Swiss, Romano, Asiago, Monterey jack, blue cheese, and any combination thereof. In one embodiment, the natural cheese is selected from the group consisting of Parmesan, Cheddar, mozzarella, Gouda, Gruyère, provolone, Swiss, Romano, Asiago, Monterey jack, blue cheese, and any combination thereof.

Parmesan cheese contains milk, salt, starter culture(s), and rennet. The temperature of the milk is raised to 33-35° C. (91-95° F.) and a suitable lactic acid bacterial starter is added. A clotting enzyme, typically rennet, is added, and the mixture is left to coagulate for 10-12 minutes. The curd is then broken up mechanically into small pieces (around the size of rice grains). The temperature is then raised to 55° C. (131° F.) with careful control by the cheese-maker. The curd is left to settle for 45-60 minutes. The compacted curd is collected in a piece of muslin before being divided in two and placed in molds. In one embodiment, the natural cheese comprises Parmesan cheese. In one embodiment, the natural cheese consists of Parmesan cheese.

Cheddar cheese is a concentrated form of milk. To manufacture Cheddar cheese, cow's milk is warmed and is subjected to the action of a lactic acid-producing bacterial culture. Clotting enzymes such as rennet is used to separate curds and whey through the formation of a semisolid mass. The mass is cut, stirred, and heated with continued stirring so as to promote and regulate the separation of whey and curd. The whey is drained off, and the curd is matted into a cohesive mass. The mass is cut into slabs, which are so piled and handled as to promote the drainage of whey and the development of acidity. The slabs are then cut into pieces, which may be rinsed by sprinkling or pouring water over them, with free and continuous drainage; but the duration of such rinsing is so limited that only the whey on the surface of such pieces is removed. The curd is salted, stirred, further drained, and pressed into forms. In one embodiment, the natural cheese comprises Cheddar cheese. In one embodiment, the natural cheese consists of Cheddar cheese. In embodiments comprising or consisting of Cheddar cheese, the natural cheese may comprise or consist of reduced fat Cheddar cheese.

To manufacture mozzarella cheese, a starter is added that contains thermophilic bacteria, and the milk is left to ripen so the bacteria can multiply. Then, rennet is added to coagulate the milk. After coagulation, the curd is cut into large, 1″-2″ pieces, and left to sit so the curds firm up in a process known as healing. After the curd heals, it is further cut into ⅜″-½″ large pieces. The curds are stirred and heated to separate the curds from the whey. The whey is then drained from the curds and the curds are placed in a hoop to form a solid mass. The curd mass is left until the pH is at around 5.2-5.5, which is the point when the cheese can be stretched and kneaded to produce a delicate consistency—this process is generally known as pasta filata. In one embodiment, the natural cheese comprises mozzarella cheese. In one embodiment, the natural cheese consists of mozzarella cheese.

In certain embodiments, the natural cheese comprises a cheese fat to cheese protein ratio of between 0 to about 1.25. In certain embodiments, the natural cheese comprises a cheese fat to cheese protein ratio of less than about 0.9. In certain embodiments, the natural cheese comprises a cheese fat to cheese protein ratio of between about 0.45 to about 1.00. In some embodiments, the natural cheese comprises a cheese fat to cheese protein ratio of between about 0.65 to about 0.90. For example, in one embodiment, the natural cheese consists of a reduced fat Cheddar cheese. In one embodiment, the reduced fat cheese comprises a fat to protein ratio of about 0.67. In other embodiments, the natural cheese consists of a parmesan cheese comprising a fat to protein ratio of between about 0.72 to about 0.89. Suitable Swiss cheese, for example, may comprise a fat to protein ratio of between about 0.49 to about 0.67.

In some embodiments, the cheese comprises a cheese moisture of between about 13% to about 80% w/w. In some embodiments, the cheese comprises a cheese moisture of between about 15% to about 60% w/w. In some embodiments, the cheese comprises a cheese moisture of between about 18% to about 45% w/w.

In certain embodiments, the natural cheese comprises at least about 15% fat. In certain embodiments, the natural cheese comprises at least about 20% fat. In certain embodiments, the natural cheese comprises at least about 25% fat. In certain embodiments, the natural cheese comprises between about 15% to about 35% fat. In certain embodiments, the natural cheese comprises between about 16% to about 22% fat. In certain embodiments, the natural cheese comprises at least about 25% protein. In certain embodiments, the natural cheese comprises between about 30% to about 40% protein.

In some embodiments, the natural cheese comprises a moisture content of less than about 55%. In such embodiments, the natural cheese may comprise a low moisture mozzarella cheese comprising about 52% moisture. Certain cheese embodiments may be made directly from either whole or part skim milk, including, for example such low moisture mozzarella cheeses.

The wheat flour, pregelatinized starch, and natural cheese is mixed with sufficient water to form a dough comprising a moisture content of between about 27% to about 35% on a wet basis. In one embodiment, the dough comprises a moisture content of between about 28% to about 30%. In one embodiment, the dough comprises a moisture content of between about 28.5% to about 29.5%. Further characteristics of the formed dough will be further described below.

In some embodiments in forming a suitable dough consistency, the cohesive dough further comprises oil. A suitable oil, for example, is any oil that is high in monosaturated fats including without limitation high oleic sunflower oil. In certain embodiments, the dough comprises between about 1% to about 8% oil. In some embodiments, the dough comprises between about 2% to about 7% oil. In some embodiments, the dough comprises between about 4% to about 6.5% oil. Added water may range from about 1% to about 12%, for example. In some embodiments, the dough comprises between about 7% to about 11% added water. In some embodiments, the dough comprises between about 2% to about 5% added water

In any of the above embodiments, the dough may comprise salt in an amount of up to about 1%. In certain embodiments, the dough comprises salt in an amount of less than about 0.8%. In certain embodiments, the dough comprises between about 0.2% and about 0.4% salt. Optional ingredients that may be included in minimal amounts (<5%) in the dough include without limitation dry components containing or derived from wheat, oat, starch, sugar, baking soda, emulsifier, hydrocolloids, enzymes, dairy, minerals, vitamins, nuts, seeds, fruits, vegetables, herbs and spices. It should be understood that some embodiments of the cohesive dough may be free of any of the aforementioned optional ingredients.

The mixing step may be performed at temperatures less than 100° F. to ensure the milk fat is in a substantially solid state. For example, vertical batch mixers or low pressure (<20 psig) continuous screw mixers may be used to produce a bulk dough which has not been formed by flowing through a die plate. Mixing times may depend upon the amount of dry ingredients as well as the mixer used. In one embodiment, mixing is performed for between about 1 to about 5 minutes. During test runs, fresh shredded or grated cheese, wheat flour, pregelatinized, starch, and salt were dry blended for about 1-2 minutes in a paddle-type mixer to form a loose mix prior to adding in the oil and water to form the cohesive dough. Thus, in some embodiments, the method may comprise a step of forming a loose mix of the dry ingredients comprising the natural cheese, prior to adding in sufficient amounts of water and/or oil to form a cohesive dough. In all embodiments described herein, the dough is free of lamination.

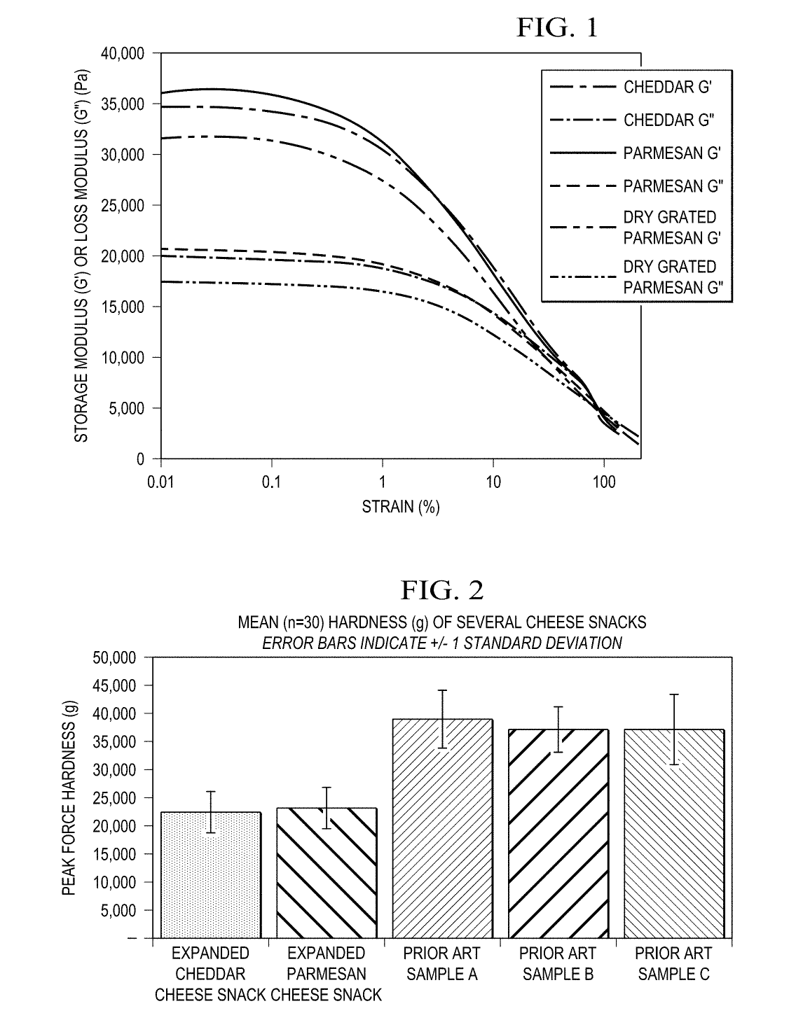

Dynamic rheological measurements of the dough provide for a measurement of strength or firmness of the dough, under oscillation. In oscillatory measurement, the viscoelastic properties of a dough can be divided into two components, the storage modulus G′ and the loss modulus G″. FIG. 1 indicates the storage modulus G′ and loss modulus G″ measure for three different sample doughs made using different natural cheeses (29% moisture), measured at 20° C. at an angular frequency of 10 rad/s. Table 1 indicates the mean (n=26 data points) storage moduli (Pa) in the linear viscoelastic region (Strain=0.01 to 1%) of these cheese snack doughs at 20° C.

TABLE 1
Mean storage moduli (Pa) of three types of cheeses

| Calculated Value | Cheddar | Parmesan | Dry Grated Parmesan |
|---|---|---|---|
| Mean | 33,746 | 35,135 | 30,677 |
| Standard Deviation | 2,135 | 4,423 | 3,464 |
| 95% Confidence | 821 | 1,700 | 1,332 |
| Interval | | | |

No difference in dough firmness (G′) was observed between doughs made with fresh cheddar or fresh Parmesan doughs when dough moisture is standardized. However, when dry grated cheese (lower moisture of about 20%) is used, dough firmness is reduced relative to fresh cheese doughs when dough moisture is held constant. This difference is resultant of a larger proportion of the moisture being more tightly bound (i.e., sourced from the cheese and not added as pure water) in the fresh cheese doughs than in the dry grated cheese dough. The mean storage modulus of certain embodiments of the dough described herein ranges from between about 23 to about 44 kPa, at 21° C. and an angular frequency of 10 rad/s. In some embodiments, the mean storage modulus ranges from between about 27 to about 40 kPa. In some embodiments, the mean storage modulus ranges from between about 29 to about 36 kPa.

Once a suitable dough is formed, the dough is sheeted. Sheeting may be done by any means known in the art and may occur in one or more steps. In one embodiment described herein for a continuous process of production, the dough is transferred via conveyor belt and may be sheeted using one or more sheeting or reduction steps or zones while moving along the conveyor belt. Any number of sheeting devices or methods may be used to roll or compress the dough into a dough sheet with a substantially uniform thickness, including without limitation compression between two or more rotating rollers. As used herein, the term “substantially uniform” refers to a nearly identical thickness throughout the sheeted dough.

In some embodiments, one or more sheeting steps may be performed on cloth, cotton/poly blend, or plastic conveyor belts to help deal with any remaining stickiness of the dough. In one embodiment, chilled rollers (about 50° F. to 65° F.) may be used to sheet the dough. A pre-cutter airstream bar or fan prior to a roller system may also be employed in some embodiments to dry the surface of the dough and reduce stickiness.

In some embodiments, the dough is sheeted to a thickness of about 2 to about 4 mm. The sheet is then formed into desired shape and size. In one embodiment, the sheet is cut using any number of cutting steps or systems. In embodiments comprising a continuous process, the cutting step may comprise one or more cutting steps and/or cutter rollers. Separate, cut pieces are then dehydrated to less than 10% moisture content. In certain embodiments, the pieces are dehydrated to less than about 4%. In certain embodiments, the pieces are dehydrated to less than about 3%. In certain embodiments, the pieces are dehydrated to less than about 2%.

Mixing, sheeting, and cutting steps described herein each occur at ambient temperatures of between about 60° F. to about 90° F. The cut pieces may be configured in any number of shapes or sizes, whether or not the cutter minimizes any wasted dough, including, for example, squares, strips, triangles, hexagons, circles, and any number of polygons, whether the edges are rounded or pointed.

It should be noted that the pieces that are dehydrated are free of any docking holes or similar materials used to stop overly large air pockets from forming while baking. Generally, the cut pieces from the cutting step undergo one or more cooking or dehydrating steps. In certain embodiments, dough pieces undergo a two-step cooking process, wherein the formed or cut pieces first undergo a baking step, followed by a second cooking step in the form of drying. In one embodiment, the baking step is a convection baking step. In one embodiment, a second cooking step comprises a dryer such as a finish dryer. For example, during test runs, cut pieces were baked to a moisture content of less than about 10% at between about 350° F. to about 425° F. for about 3-4 minutes, followed by drying to the shelf stable moisture content of less than about 4%, in a finish dryer for about 20 to 30 minutes at a temperature of about 250° F. to 275° F. In some embodiments, a single heating step may also be used to arrive at a desirable product.

The finished product described herein comprises peak force hardness of between about 15,000 to about 30,000 grams, based on compression with a plate. Such values may be determined, for example, using a TA-30 compression plate, at a test speed of 20 mm per second and 85% strain. In some embodiments, the finished product comprises a peak force hardness of between about 18,800 to about 27,000 grams. In certain embodiments, the finished product comprises a peak force hardness of between about 20,000 to about 25,000 grams. Table 2 reflects the values determined using such testing for two samples of the presently described expanded cheese snacks as well as those of prior art cheese snacks A-C.

TABLE 2
Hardness (g) of cheese snacks

| | Expanded | Expanded | | | |
|---|---|---|---|---|---|
| | Cheddar | Parmesan | | | |
| | Cheese | Cheese | Prior Art | Prior Art | Prior Art |
| | Sample | Sample | Sample A | Sample B | Sample C |
| | Peak Force, Hardness (g) | | | | |
| Average of | 22,565 | 23,331 | 38,932 | 37,325 | 37,306 |
| 30 samples | | | | | |
| Standard | 3,741 | 3,623 | 5,285 | 4,148 | 6,420 |
| Deviation | | | | | |
| Coefficient | 16.58 | 15.53 | 13.57 | 11.11 | 17.21 |
| of Variation | | | | | |

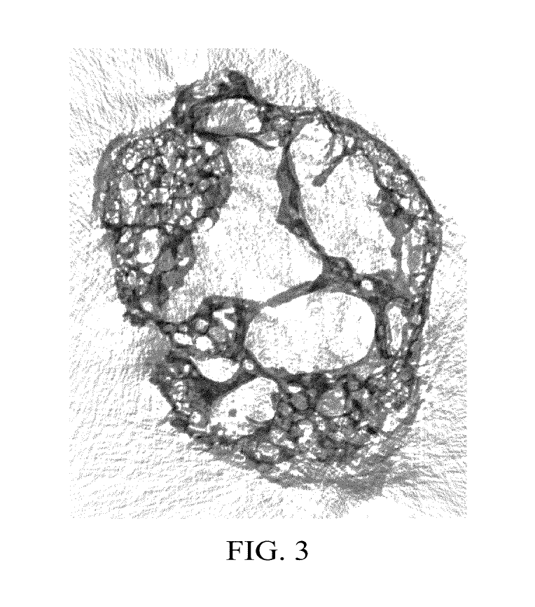

FIG. 2 reflects these value differences in hardness between the cheese snack products described herein and prior art cheese snack products. As demonstrated by the above values and FIG. 2, the presently described cheese snack products are lighter than other cheese snack cracker foods. This lighter texture is caused by the irregular and open internal air cell structure shown in FIG. 3.

The finished product further comprises a bulk density of between about 100 to about 400 g/L. In some embodiments, the finished product comprises a bulk density of between about 100 to about 400 g/L. In some embodiments, the finished product comprises a bulk density of between about 180 to about 220 g/L. In some embodiments, the product comprises a piece weight of between about 7 to about 20 grams per 10 pieces. In some embodiments, the product comprises a piece weight of between about 8 to about 15 grams per 10 pieces. In some embodiments, the product comprises a piece weight of between about 8 to about 10 grams per 10 pieces.

After dehydration to a shelf-stable moisture content, the finished product may be subjected to seasoning steps and/or packaging prior to consumption. A shelf stable snack food produced by the method described herein is light and crispy and comprises an irregular and open internal air cell structure throughout its interior.

The methods described herein may be performed on a batch or continuous basis. In one embodiment, the method described is a continuous process, meaning a process that operates with a substantially or entirely uninterrupted flow of materials into and/or resulting from the process. In one embodiment, a continuous process is one that creates a throughput of at least about 250 lbs/hour. In one embodiment, a continuous process is one that creates a throughput of about 1,000 lbs/hour. In one embodiment, a continuous process may also include one or more steps performed manually or by other batch-wise means. The methods disclosed herein may be suitably practiced in the absence of any element, limitation, or step that is not specifically disclosed herein. For example, the method described herein is free of extrusion and free of pelletization steps. Similarly, specific snack food embodiments described herein may be obtained in the absence of any component not specifically described herein.

While this invention has been particularly shown and described with reference to several embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method of making a snack food, said method comprising the steps of:
mixing wheat flour, pregelatinized starch, natural cheese and water to form a cohesive dough, the natural cheese comprising a moisture greater than 5% and the cohesive dough comprising at least about 40% natural cheese;
sheeting said cohesive dough to form a sheeted dough;
cutting said sheeted dough to form a plurality of cut pieces; and
dehydrating the baked pieces to less than 10% to form a snack food comprising at least about 35% natural cheese.

2. The method of claim 1 wherein said cohesive dough comprises a moisture of between about 27% to about 35% by wet weight.

3. The method of claim 1 wherein said cohesive dough comprises between about 15% to about 28% wheat flour.

4. The method of claim 1 said natural cheese comprising Parmesan, Cheddar, mozzarella, Gouda, Gruyère, provolone, Swiss, Romano, Asiago, Monterey jack, blue cheese, or any combination thereof.

5. The method of claim 1 wherein said natural cheese comprises Cheddar cheese.

6. The method of claim 1 wherein said natural cheese comprises mozzarella cheese.

7. The method of claim 1 wherein said natural cheese is Parmesan cheese.

8. The method of claim 1 wherein said natural cheese comprises a cheese fat to cheese protein ratio of between 0 to about 1.25.

9. The method of claim 1 wherein the cohesive dough comprises between 15% to about 25% pregelatinized starch.

10. The method of claim 1 wherein said cohesive dough further comprises oil.

11. The method of claim 10 wherein said cohesive dough comprises between about 1% to about 8% oil.

12. The method of claim 10 wherein the cheese comprises greater than 20% fat.

13. The method of claim 1 wherein the mixing step comprises between about 1% to about 12% water.

14. The method of claim 1 wherein said shelf stable snack foods comprise a peak force hardness of between about 15,000 to about 30,000 grams.

15. The method of claim 1 wherein the cutting step comprises more than one cutting process prior to the dehydrating step.

16. The method of claim 1 wherein the cutting step comprising more than one cutting process.

17. The method of claim 16 wherein the drying process reduces the moisture content to less than 3%.

18. A product made by the method of claim 1.

19. A shelf-stable snack food product comprising:
at least about 35% natural cheese, the natural cheese comprising at least 15% fat;
between about 23% to about 30% wheat flour;
between about 23% to about 30% pregelatinized starch;
a moisture content of less than 4%; and
a peak force hardness of between about 15,000 to about 30,000 grams.

20. The snack food product of claim 19 wherein said natural cheese comprises a fat to protein ratio of less than about 0.9.

21. The snack food product of claim 19 wherein said natural cheese comprises Parmesan, Cheddar, mozzarella, Gouda, Gruyère, provolone, Swiss, Romano, Asiago, Monterey jack, blue cheese, or any combination thereof.

22. The snack food product of claim 19 wherein said natural cheese comprises a fat to protein ratio of between about 0.4 to about 0.9.

23. The snack food product of claim 19 comprising between about 2% to about 3% moisture.

24. The snack food product of claim 19 comprising less than 10% oil.

25. The snack food product of claim 19 wherein said wheat flour comprises a flour protein content of between about 8% to about 15%.

26. A dough comprising:
between about 15% to about 28% wheat flour;
between 15% to about 25% pregelatinized starch;
at least 40% natural cheese, the natural cheese comprising an unprocessed, non-powder cheese;
between about 1% to about 12% added water; and
a mean storage modulus from between about 23 to about 44 kPa, at 21° C. and an angular frequency of 10 rad/s.

27. The dough of claim 26 comprising oil.

28. The dough of claim 27 comprising between about 1% to about 8% oil.

29. The dough of claim 26 wherein the said natural cheese comprises Parmesan, Cheddar, mozzarella, Gouda, Gruyère, provolone, Swiss, Romano, Asiago, Monterey jack, blue cheese, or any combination thereof.
